(19) United States
(12) Patent Application Publication
(10) Pub. No.: US 2006/0185944 A1
(43) Pub. Date: Aug. 24, 2006

(54) Integrated motorcycle brake and suspension system

(76) Inventor: Vincenzo F. Costa, Hungtington Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 11/062,196

(22) Filed: Feb. 18, 2005

(51) Int. Cl. F16D 65/00; F16F 9/00

(52) U.S. Cl. 188/73.1; 188/322.19

(57) ABSTRACT

A motorcycle brake and suspension system comprising: an outer tube, having an upper end and a lower end, a mainspring mounted inside the outer tube, a brake line, traveling through the central axis of the outer tube and looped to allow slack, and a braking system actuated by the brake line. A flexible plastic cover fits over the brake line. The brake line actuates an integrated padlock caliper disk brake. A fender bracket mounted on the brake caliper. The integrated padlock caliper disk brake system has integrally formed brake fluid passages in the fork leg hydraulically operative inside the load bearing portion of the fork leg. An adjustable push rod supports the mainspring, the adjustable push rod adjusting the neutral position length of the mainspring.

### DISCUSSION OF RELATED ART

Traditionally, motorcycle front fork components such as brake calipers have been mounted to the exterior of the motorcycle fork frame. This allows easier maintenance and replacement of components such as brakes. Unfortunately, it also allows dust and other foreign objects to interact with the components. Shielding can also be added on exterior brake lines and components, unfortunately this adds additional complexity and cost.

### BRIEF DESCRIPTION OF THE DRAWINGS

FIG. 1 is an exploded view of the caliper leg of the invention.

FIG. 2 is an exploded view of the push rod assembly.

FIG. 3 is an exploded view of the outer tube.

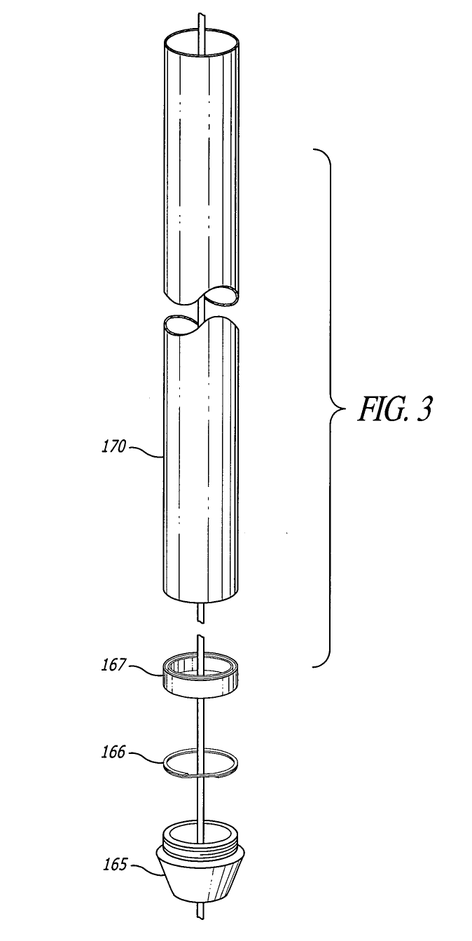

FIG. 4 is an exploded view of the assembly of the piston in relation to the top out and bottom out spring.

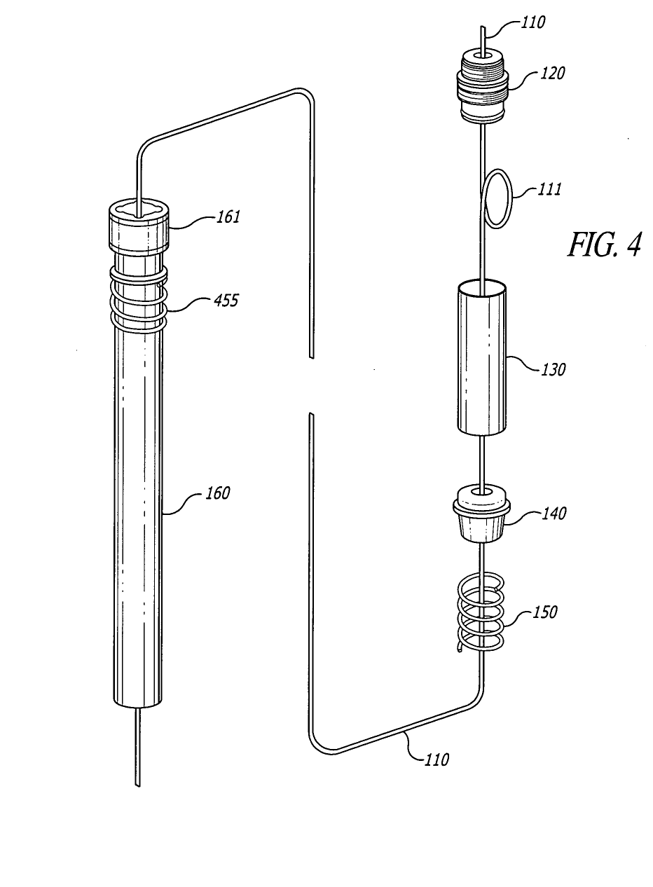

FIG. 5 is an exploded view of the lower leg showing the disk brake.

FIG. 6 is a cross section view of the assembled invention.

### DETAILED DESCRIPTION OF THE PREFERRED EMBODIMENT

The present invention is an integrated motorcycle brake and suspension system. Two members form a pair of suspension members forming the fork. The suspension members are similar in operation, and physical components, but the brake caliper leg has an internal brake line and an integrated brake. The suspension system of the brake caliper leg has the main spring 185 and a top out spring 455 as well as a bottom out spring 150.

The term top out refers to the situation when the motorcycle suspension system is pulled away from the motorcycle. Thus, the top out spring preferably being stiffer than the mainspring operates when operational conditions have exceeded the mainspring capabilities. Similarly, the bottom out spring 150 protects against a bottom out which is the situation where the operational conditions have exceeded the mainspring capabilities, such as when a user hits a speed bump at high speed or debris on a road causing the suspension system to be pushed against the motorcycle. The top out and bottom out spring should be stiffer than the mainspring.

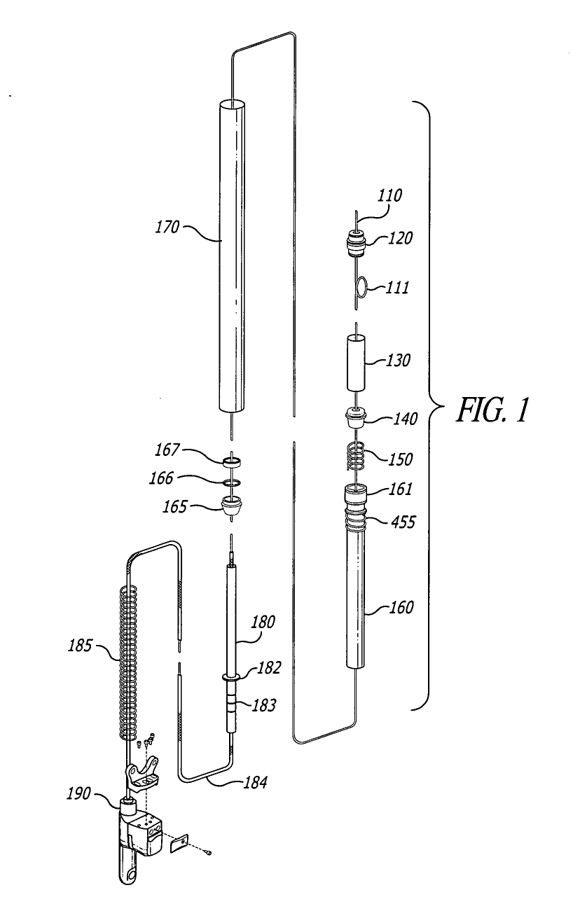

The brake line 110, FIG. 1 runs from the manually operated brake actuator through the central axis of the outer tube. It first passes through an upper retainer 120 also called a body cap in this specific embodiment. The upper retainer has seals retaining oil within the system. The brake line 110 then passes through a variety of load bearing hollow tubes starting with an upper cylinder 130 whereby the brake line 110 forms a line loop 111. The line loop preferably forms a complete loop. The line loop 111 is not attached to other elements, and allows slack when the telescoping components move and change the length of the motorcycle suspension system. The motorcycle suspension system moves during normal riding and may move more during riding on uneven surfaces.

The upper cylinder attaches to an upper plug also called a spring top 140. The upper cylinder 130 is also called the bottom out spacer 130 in this particular embodiment. The bottom out spacer 130 preferably retains the line loop 111. The bottom out spacer 130 attaches to the body cap 120 above, and the spring top 140 below. The bottom out spacer dimensions affect the performance of the suspension system.

The upper plug receives an upper spring also called the bottom out spring 150 that rests against a inner tube 160. The inner tube assembly 160 fits in telescoping configuration inside the main housing formed as a cylinder 170. The main housing formed as cylinder 170 is also called the outer tube because it encloses substantially all of the other components including the bottom out spacer 130, spring top 140, bottom out spring 150, topped out spring 455, the upper portion of the inner tube 160, and the push rod tube 180. The outer tube is what casual observers see, hiding all of the other components inside. Casual observers would also see the inner tube 160 inside and below the outer tube. The seal cover 165 receives an annular seal retainer that is the snap ring 166 and an oil seal formed as a ring 167. The seal cover 165 fits over the adjustable height assembly, here formed as a push rod 180. The adjustable push rod 180 adjusts the neutral position length of the mainspring.

The adjustable height assembly 180 is hollow allowing the brake line 110 to pass through. The adjustable height assembly 180 has a retaining clip shown here as a snap ring 182 retained within one of a plurality of pushrod tube grooves 183. A rigid flexible sleeve 184 encapsulates the brake line 110. A main spring 185 that is the lowest spring rests against the retaining clip 182, spring washer 188 and supports the system.

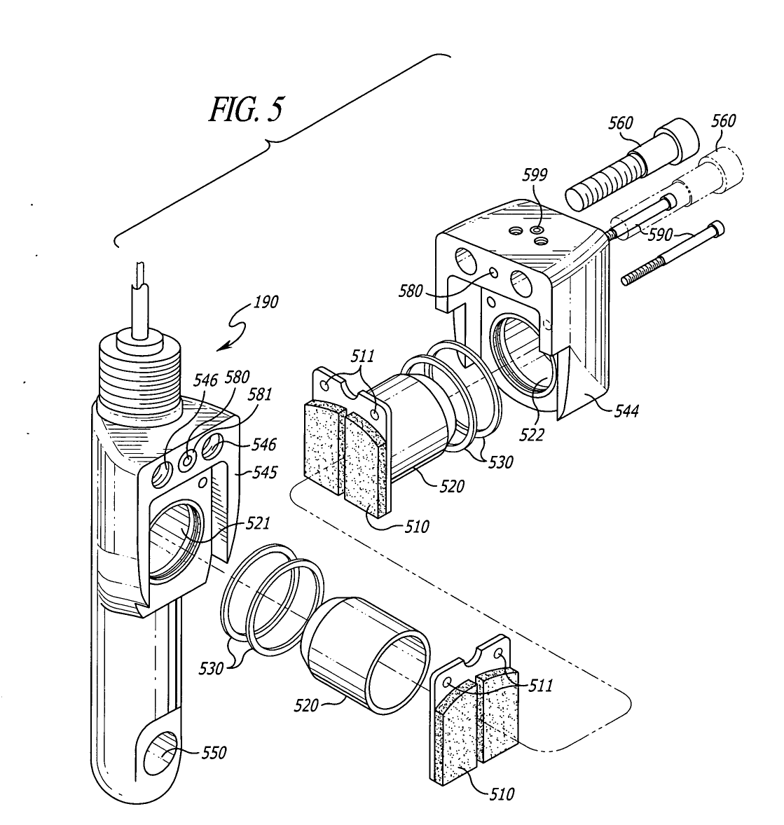

The brake line has dynamically varying hydraulic pressure, and is typically filled with oil. The brake line terminates at the disk brake assembly 190. FIG. 5, the disk brake has a pair of brake pads 510 biased together by a pair of brake pistons 520. Brake pistons 520 are sealed with o-ring seals 530. The seals maintain hydraulic pressure, transmitting the brake line pressure against the Pistons 520 that transmit pressure against the brake pads 510 that transmit pressure against the disk portion of a wheel. The wheel is mounted on the wheel axis shown as aperture 550.

The disk brake assembly 190 is formed of a pair of piston assemblies. The disk brake assembly 190 includes a pair of bolts 560 that are partially threaded and secure the outside brake assembly 544 against the inside brake assembly 545. The bolts 560 secure into threads 546. The brake line hydraulic pressure is transmitted from the inside brake assembly 545 the outside brake assembly 544 via a conduit 580. A seal 581 seals the conduit as seen in FIG. 5 at an interface. The inside piston aperture 521 opposes the outside piston aperture 522. Preferably, a pair of bolts 590 secure through the outside brake assembly 544 and pass through the brake pads 510 at brake pad guide points 511, and secure into threads in the inside brake assembly. Preferably, a bleeder cap 599 will allow drainage of the hydraulic fluid, such as oil or water.

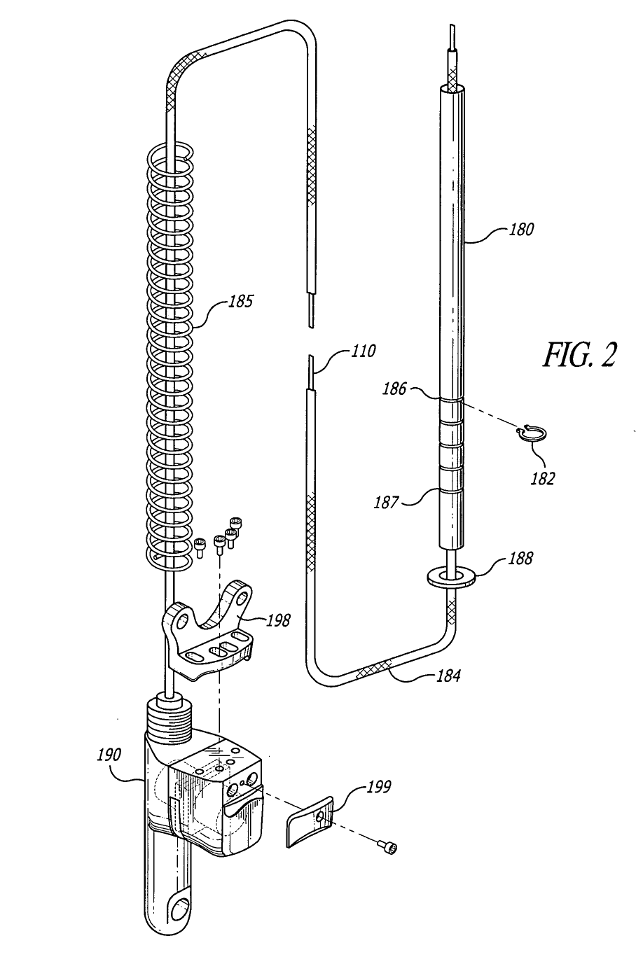

FIG. 2 shows the adjustable height assembly 180 receiving the retaining clip 182 in the top position 186. The top position 186 is above the other five positions and the lower position 187. The retaining clip 182 supports a retaining washer 188 that rests against the retaining clip 182. The rigid sleeve 184 although shown as bent in the drawing is actually substantially straight, and supports the line 110. The main spring 185 rests against the retaining washer 188.

A fender mount 198 is attached to the disk brake assembly 190 integral to the lower leg 190 allowing a fender to be mounted to the motorcycle. The fender mount 198 is preferably secured to the disk brake assembly by four machine screws as the scene in FIG. 2. A faceplate also called a tombstone 199 allows a cleaner look and keeps dust out by covering the various apertures and bolt head formed by the bolts 590, 560.

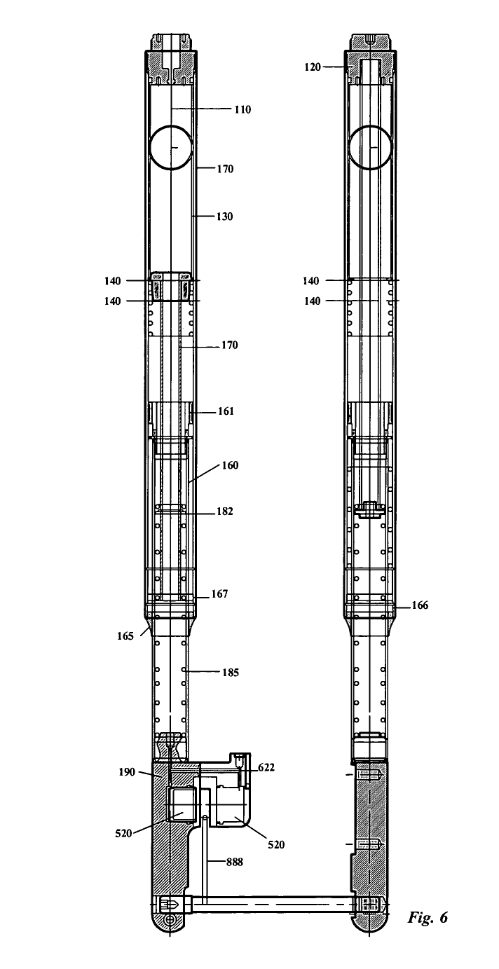

FIG. 6 shows that the spring top 140 receives the push rod 180 that rests the mainspring. Also, FIG. 6 shows the correct assembly of the components shown in FIG. 1. The spring top 140 receives both the bottom out spring 150 and the push rod tube 180. The load is transmitted through the push rod tube 180. The bottom out spring 150 interacts with the piston 161 upon extreme operating conditions. The piston 161 is held snugly within the outer tube 170. Oil passes through ports located in the walls of the inner tube 160. Inner tube 160 has ports that are preferably below the piston 161 attached to the inner tube 160.

The inside piston assembly is integrally formed to the caliper leg of the fork. Here, the inside piston assembly is made of the same piece of metal that supports the fork. An axle is held between the pair of fork legs.

After assembly, the device is partially filled with oil, leaving an air gap at the top. The device should be filled with oil above the position of the piston, allowing the piston to be lubricated. The oil also adds dampening. After the device is filled with oil, it can be mounted on the motorcycle so that it receives a brake rotor 888 between the brake pads.

1. A motorcycle brake and suspension system comprising:
an outer tube, having an upper end and a lower end,
a mainspring mounted inside the outer tube,
a brake line, traveling through the central axis of the outer tube and looped to allow slack, and
a braking system actuated by the brake line.

2. The motorcycle brake and suspension system of claim 1 further comprising a flexible plastic cover over brake line.

3. A motorcycle brake and suspension system comprising:
an outer tube, having an upper end and a lower end,
a mainspring mounted inside the outer tube,
a brake line, traveling through the central axis of the outer tube from the upper end to the lower end, and
an integrated caliper disk brake actuated by the brake line.

4. The motorcycle brake and suspension system of claim 3 further comprising a fender bracket mounted on the brake caliper.

5. A motorcycle brake and suspension system comprising:
an outer tube, having an upper end and a lower end,
a mainspring mounted inside the outer tube,
a brake line, traveling through the central axis of the outer tube from the upper end to the lower end, and
an integrated padlock caliper disk brake system actuated by the brake line, the padlock caliper disk brake system having integrally formed brake fluid passages in the fork leg.

6. The motorcycle brake and suspension system of claim 5 wherein the integrally formed brake fluid passages are hydraulically operative inside the load bearing portion of the fork leg.

7. The motorcycle brake and suspension system of claim 5 wherein the integrally formed brake fluid passages are formed by machining, casting or forging the fork leg.

8. The motorcycle brake and suspension system of claim 5 further comprising an adjustable push rod supporting the mainspring, the adjustable push rod adjusting the neutral position length of the mainspring.
